(19) United States
(12) Patent Application Publication
(10) Pub. No.: US 2023/0156434 A1
(43) Pub. Date: May 18, 2023

(54) APPARATUS AND METHOD FOR UNICAST, BROADCAST, AND MULTICAST SERVICES

(71) Applicant: JRD COMMUNICATION (SHENZHEN) LTD., Shenzhen, Guangdong (CN)

(72) Inventors: Ahmed MOHAMMED MIKAEIL, Shenzhen, Guangdong (CN); Jia SHENG, Shenzhen, Guangdong (CN)

(73) Assignee: JRD COMMUNICATION (SHENZHEN) LTD., Shenzhen, Guangdong (CN)

(21) Appl. No.: 17/995,858

(22) PCT Filed: Apr. 10, 2020
(86) PCT No.: PCT/CN2020/084276

§ 371 Date: Oct. 9, 2022

(51) Int. Cl. H04W 4/06; H04W 72/23; H04W 72/0446; H04W 72/0453

(52) U.S. Cl. CPC H04W 4/06; H04W 72/23; H04W 72/0446; H04W 72/0453

(57) ABSTRACT

A method for unicast, broadcast and multicast services executable by a user equipment (UE) is provided. The UE transmits an indication message to indicate a first intended service of a first traffic type and a second intended service of a second traffic type to the network. The first traffic type may be unicast traffic, and the second traffic type may be multimedia broadcast/multicast service (MBMS) traffic. The UE receives downlink configuration, which is generated by the network based on the indication message, and receives a downlink frame carrying the first intended service and the second intended service according to the downlink configuration.

### BACKGROUND OF DISCLOSURE

### 1. Field of Disclosure

The present disclosure relates to the field of wireless communication, and more particularly, to a multimedia broadcast/multicast service (MBMS) system.

### 2. Description of Related Art

Multimedia broadcast/multicast service (MBMS) is a point-to-multipoint interface designed to provide efficient delivery of broadcast and multicast services in Third Generation Partnership Project (3GPP) cellular networks. MBMS delivers multicast services within a single cell using single cell point to multipoint (SC-PTM) transmission, and delivers broadcast services within a group of multiples cells using multimedia broadcast multicast service single frequency network (MBSFN) transmission. SC-PTM uses the same Long Term Evolution (LTE) downlink shared channel and subframe structure for transmission while MBSFN defines new channels and has a different subframe structure than a regular subframe LTE to ensure the transmission over a group of cells.

### Technical Problem

Current LTE MBMS design in technical specification (TS) 36.300 and TS 36.331 has problems to support future MBMS and unicast applications, especially in MBSFN transmission mode. The information elements (IEs) used to indicate the information, values, and parameters regarding MBMS and unicast reception operation, which is transmitted by a user equipment (UE) to an operator network, are insufficient or not well defined to support fifth generation (5G) use cases. A solution to the problems is desired, but no solution is proposed or considered by 3GPP. Improving the MBMS specifications to address these problems are essential to achieve new radio (NR) MBMS.

### SUMMARY

An object of the present disclosure is to propose an apparatus and a method. The methods proposed in this disclosure provide some UE side RAN enhancements related to the support of simultaneous operation of MBMS and unicast in NR system.

In a first aspect, the present disclosure provides a method for unicast, broadcast, and multicast services, executable by a user equipment, comprising: transmitting an indication message to indicate a first intended service of a first traffic type and a second intended service of a second traffic type, wherein one of the first traffic type and the second traffic type is unicast traffic, and the other one of the first traffic type and the second traffic type is non-unicast traffic; receiving downlink configuration which is generated based on the indication message; and receiving a downlink frame carrying the first intended service and the second intended service according to the downlink configuration.

In an embodiment of the disclosure, the method further comprises receiving a first radio resource unit of the first intended service and a second radio resource unit of the second intended service according to the downlink configuration, wherein the first radio resource unit and the second radio resource unit are multiplexed into different time slots on a same frequency band.

In an embodiment of the disclosure, the method further comprises receiving a first radio resource unit of the first intended service and a second radio resource unit of the second intended service according to the downlink configuration, wherein the first radio resource unit and the second radio resource unit are multiplexed on different frequency bands.

In a second aspect, the present disclosure provides a method for unicast, broadcast, and multicast services, executable by a user equipment, comprising: receiving an indication message indicating a first intended service of a first traffic type and a second intended service of a second traffic type, wherein one of the first traffic type and the second traffic type is unicast traffic, and the other one of the first traffic type and the second traffic type is non-unicast traffic; transmitting downlink configuration which is generated based on the indication message; and transmitting a downlink frame carrying the first intended service and the second intended service according to the downlink configuration.

In an embodiment of the disclosure, the method further comprises transmitting a first radio resource unit of the first intended service and a second radio resource unit of the second intended service according to the downlink configuration, wherein the first radio resource unit and the second radio resource unit are multiplexed into different time slots on a same frequency band.

In an embodiment of the disclosure, the method further comprises transmitting a first radio resource unit of the first intended service and a second radio resource unit of the second intended service according to the downlink configuration, wherein the first radio resource unit and the second radio resource unit are multiplexed on different frequency bands.

In a third aspect, the present disclosure provides an apparatus a transceiver and a processor connected with the transceiver. The processor is configured to execute the following steps comprising: transmitting an indication message to indicate a first intended service of a first traffic type and a second intended service of a second traffic type, wherein one of the first traffic type and the second traffic type is unicast traffic, and the other one of the first traffic type and the second traffic type is non-unicast traffic; receiving downlink configuration which is generated based on the indication message; and receiving a downlink frame carrying the first intended service and the second intended service according to the downlink configuration.

In a fourth aspect, the present disclosure provides a radio node comprising a transceiver and a processor connected with the transceiver. The processor is configured to execute the following steps comprising: receiving an indication message indicating a first intended service of a first traffic type and a second intended service of a second traffic type, wherein one of the first traffic type and the second traffic type is unicast traffic, and the other one of the first traffic type and the second traffic type is non-unicast traffic; transmitting downlink configuration which is generated based on the indication message; and transmitting a downlink frame carrying the first intended service and the second intended service according to the downlink configuration.

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as computer program product, that causes a computer to execute the disclosed method.

The disclosed method may be programmed as computer program, that causes a computer to execute the disclosed method.

### Advantageous Effects

The main advantages of the disclosed methods over the existing LTE design include:

In LTE MBMS, no information or indication is provided to the radio access network (RAN) regarding the ongoing unicast services, and the information or indication regarding the ongoing MBMS services is only provided in the SC-PTM MBMS mode, which makes it difficult for the network to decide how to multiplex the unicast and MBMS transmission toward UE. The disclosure redefines and provides additional IEs for UE to indicate such information and to assist the network to configure the transmission of MBMS and unicast services.

Additionally, LTE MBMS IEs used to indicate the UE reception mode to RAN support only two types of reception modes: either unicast reception mode or MBMS reception mode. The disclosure provides the support of simultaneous reception of MBMS and unicast in addition to the unicast mode and MBMS reception mode.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures.

FIG. 1 is a schematic diagram showing a system according to an embodiment of the present disclosure.

FIG. 2 is a schematic diagram showing an example of 5G core network.

FIG. 3 is a schematic diagram showing a mobile terminal and a network executing the method according to an embodiment of the present disclosure.

FIG. 4 is a flowchart showing a method according to an embodiment of the present disclosure.

FIG. 5 is a schematic diagram showing indication messages and downlink reconfiguration in a single band MBMS deployment scenario.

FIG. 6 is a schematic diagram showing indication messages and downlink reconfiguration in a multiband MBMS deployment scenario.

FIG. 7 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In current MBMS design, information elements (IEs) for communication between a user equipment (UE) and an operator network (NW) regarding MBMS and unicast reception operation are insufficient to support simultaneous MBMS and unicast reception. Only MBMS related IEs are available while no unicast related IE is provided. Thus, new IEs for communication between a UE and a NW regarding unicast services is desired in NR based MBMS. The new IEs may be defined in NR to facilitate the simultaneous reception of MBMS and unicast.

An objective of the invention is to resolve the above-identified problems. The disclosure provides a method and an apparatus to overcome the identified problems and allow UE to receive MBMS and unicast service simultaneously in an NR system. The disclosure provides a method that allows UE to simultaneously receive MBMS and unicast services. The method includes a UE sending an interest indication message to the network. The indication message contains at least one of the following: a list of ongoing or intended MBMS and unicast services, a list of carrier frequencies for the services, and one or more reception modes supported by the UE. In response to the indication message, the network configures downlink (DL) transmission of MBMS only, unicast only, or simultaneous MBMS and unicast services over NR downlink, and sends radio frames of the configured downlink transmission to the UE.

In the description, an intended service in the disclosure may represent a service of one of broadcast, multicast, groupcast, and unicast traffic types a UE is to or intends to receive. A frequency may represent a frequency range or a frequency band defined based on the frequency for transmission of at least one of the intended services.

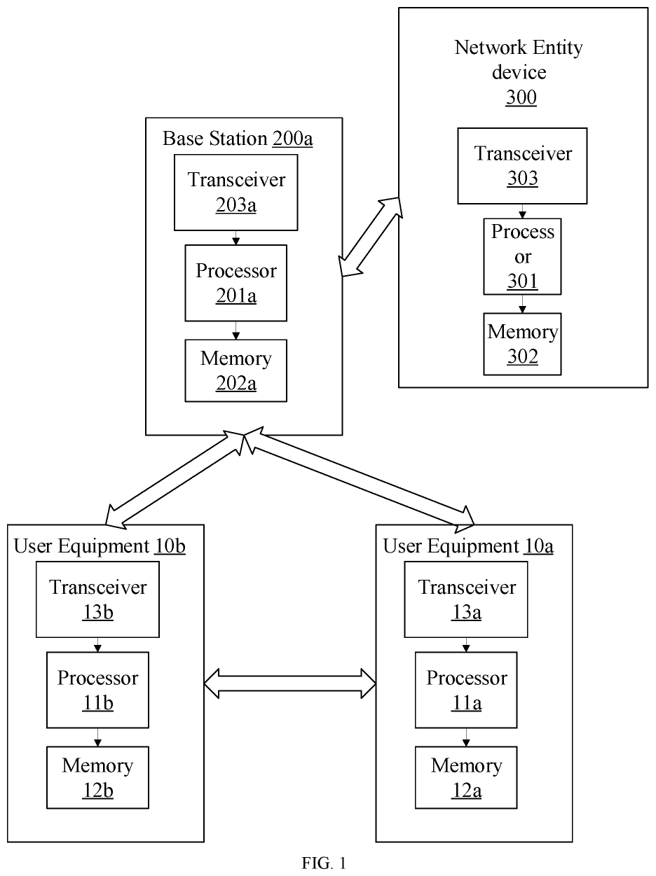

With reference to FIG. 1, a UE 10a, a UE 10b, a base station 200a, and a network entity device 300 executes a method according to an embodiment of the present disclosure. Connections between devices and device components are shown as lines and arrows in the FIG. 1. The UE 10a may include a processor 11a, a memory 12a, and a transceiver 13a. The UE 10b may include a processor 11b, a memory 12b, and a transceiver 13b. The base station 200a may include a processor 201a, a memory 202a, and a transceiver 203a. The network entity device 300 may include a processor 301, a memory 302, and a transceiver 303. Each of the processors 11a, 11b, 201a, and 301 may be configured to implement proposed functions, procedures and/or methods described in this description. Layers of radio interface protocols may be implemented in the processors 11a, 11b, 201a, and 301. Each of the memory 12a, 12b, 202a, and 302 operatively stores a variety of program and information to operate a connected processor. Each of the transceiver 13a, 13b, 203a, and 303 is operatively coupled with a connected processor, transmits and/or receives radio signals. The base station 200a may be an eNB, a gNB, or one of other radio nodes.

Each of the processor 11a, 11b, 201a, and 301 may include a general-purpose central processing unit (CPU), an application-specific integrated circuits (ASICs), other chipsets, logic circuits and/or data processing devices. Each of the memory 12a, 12b, 202a, and 302 may include a read-only memory (ROM), a random access memory (RAM), a flash memory, a memory card, a storage medium, other storage devices, and/or any combination of the memory and storage devices. Each of the transceiver 13a, 13b, 203a, and 303 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The network entity device 300 may be a node in a central network (CN). CN may include LTE CN or 5G core (5GC) which may include user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), the network exposure function (NEF), and other network entities.

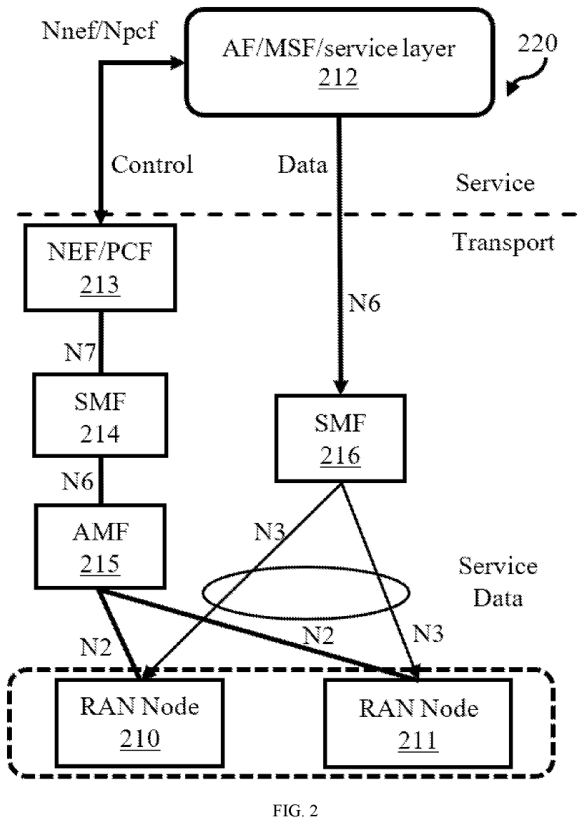

The 5G NR system reuses as much as possible the current unicast service architecture and procedures to deliver for MBMS services. For example, with reference to FIG. 2, the application function (AF) 212 in a 5GC 220 is enhanced by introducing a new network function called multicast service function (MSF) which provides MBMS service layer functionality via Npcf or Nnef interface. The network exposure function (NEF) and the policy control function (PCF) 213 are enhanced to exchange 5G MBMS quality of service (QoS) and service area related information with AF 212, and the session policy related information with the session management function (SMF) 214. The functions of SMF 216 and the user plane function (UPF) are enhanced to support the configuration/controls of MBMS flows. The access and mobility function (AMF) 215 is also enhanced to support managing of transmission resources for MBMS across next generation radio access network (NG-RAN) nodes 210 and 211. Interfaces N2, N3, N6, and N7 are defined in 5G related standards.

MBMS operation is detailed in the following.

To deliver MBMS over one same LTE frame with unicast service, MBMS related network entities may combine the transmission of an LTE physical downlink shared channels (PDSCH) with a physical multicast channel (PMCH) in the same LTE radio frame. An MBMS capable UE can camp on “RRC_IDLE” LTE cell, access stratum configuration, and read system information SIB2 broadcasted by the cell on Broadcast Control Channel (BCCH) to discover availability of eMBMS service. The UE may interpret SIB2 to identify MBMS subframes allocation configuration. The MBMS subframes allocation specifies which subframes are reserved for MBSFN transmissions on the PMCH and which subframes are reserved for unicast transmissions on the PDSCH. The MBSFN subframes has a repetition period of 1 to 32 frames and do not interfere with subframes used for paging or synchronization signals. After determining the subframes allocated for MBMS, the UE intending to receive MBMS services may continue reading SIB13 which carries MBSFN area configuration information and the medium access control (MAC) control element for multicast channel (MCH) scheduling information (MSI). The UE may interpret the SIB13 to acquire the following information: (1) the MBSFN area identifier of each area supported by the cell; (2) the information regarding MCCH channel including the MCCH repetition period such as 32, 64, . . . , or 256 frames, the MCCH offset, such as 0, 1, . . . , or 10 frames, the MCCH modification period, such as 512, or 1024 frames, a modulation and coding scheme (MCS), the subframe allocation information for MCCH indicated by the repetition period and offset; and (3) an MCCH change notification configuration.

The UE may interpret the acquired information to receive MCH channel which carries an RRC signaling message about MBSFN area configuration. Each MBSFN area is associated with one MBSFN area configuration message. The MBSFN area configuration message includes: (1) the temporary mobile group identity (TMGI) and the session identifier for each multicast traffic channels (MTCH) which is identified by a logical channel identifier in each PMCH; (2) the allocated resources for each PMCH in the area and the allocation period, such as 4, 8, . . . , or 256 frames, of the allocated resources for all the PMCHs within the area; and (3) the MCH scheduling period (MSP), such as 8, 16, . . . , or 1024 radio frames, over which the MSI MAC control element is transmitted. The MSI MAC control element is transmitted on the first subframe of each scheduling period of the PMCH. The MSI indicates an end of the frame and subframe of each MTCH within the PMCH for the UE. The UE can read this control element to receive an instance of MTCH channel. To determine the frequency that provide the MBMS service to be received by UE, the UE may check user service description (USD) and/or read SIB15 which includes a list contain the current frequency and the neighboring frequencies, where each frequency in the list is associated with a list of MBMS service area identities (SAIs) that is supported by the respective frequency while the USD includes a TMGI corresponding to each MBMS SAI, and further includes information associating the TMGIs and SAIs. For one or more MBMS services of interest, the UE may use information provided by SIB15 and the USD to determine the MBMS SAIs associated with the corresponding TMGI(s) of interest, and then specifies the frequency or frequencies associated with the MBMS SAIs as the frequency or frequencies of interests. After determining the frequency or frequencies of interests UE can sends an RRC signaling message known as MBMS interest indication message to the network to inform about intended MBMS service or services provided by the respective frequency or frequencies.

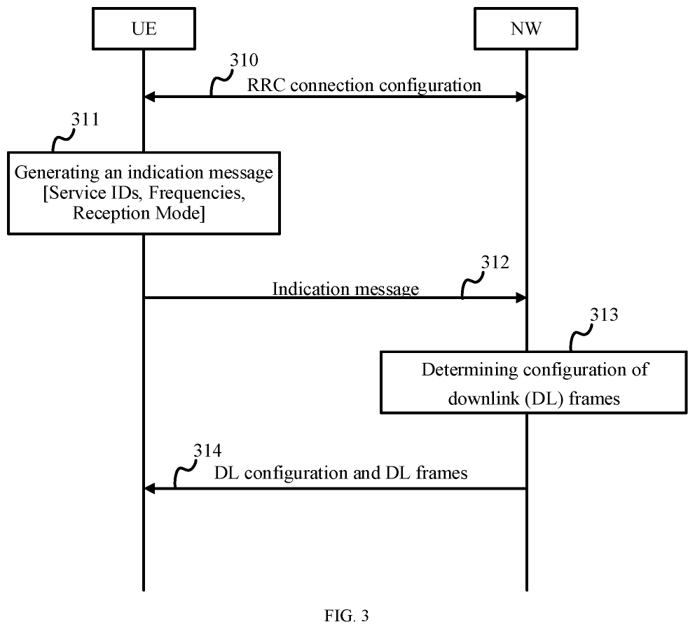

The disclosure provides a method allowing a UE, such as one of the UEs 10a and 10b, to receive MBMS and unicast service in the 5G NR system. With reference to FIG. 3, the UE is in in an RRC connected mode (step 310). The UE in an RRC connected mode determines an intended traffic type (step 311) and sends an indication message including intended service IDs representing the intended traffic type, carrier frequencies, and a reception mode, to the NW, such as one or both of the base station 200a and the NW entity 300 (step 312). The NW determines and configures a traffic type represented by the service IDs on NR downlink (step 313) and sends radio frames of the configured traffic type to the UE (step 314).

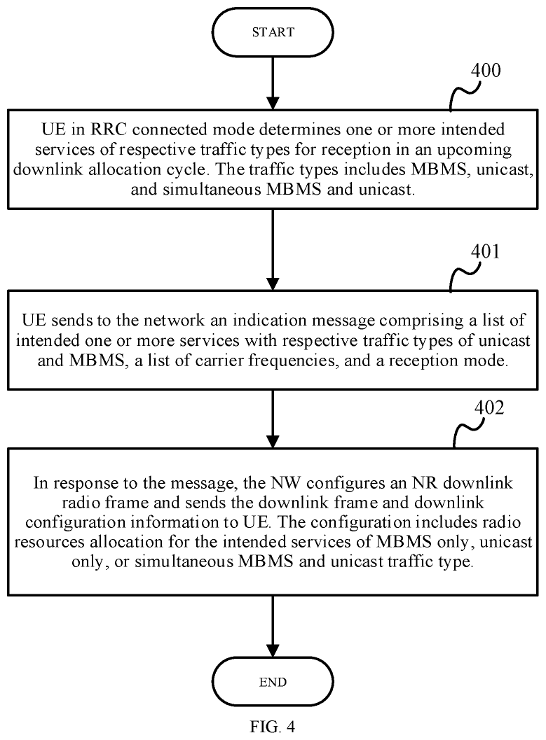

With reference to FIG. 4, the UE in an RRC connected mode determines one or more intended services of one or more traffic types (block 400) and sends an indication message to the NW, such as one or both of the base station 200a and the NW entity 300 (block 401). The traffic types include MBMS, unicast, and simultaneous MBMS and unicast. The indication message includes a list of intended one or more services, a list of service carrier frequencies, and a reception mode of the UE. The list of intended services is a list of radio data bearers of the ongoing or intended services. For example, the radio data bearers may be identified by service identities (IDs). The UE may send the indication message periodically at the granularity of one NR radio frame. The message may also include a list of frequencies for the ongoing or intended MBMS and unicast services and the current supported reception mode of the UE. The current supported reception mode of the UE may include one of unicast only, MBMS only, and simultaneous MBMS and unicast reception modes. In response to the received indication message from UE, the NW configures NR downlink, generates an NR downlink radio frame to include the intended services of respective traffic types, and sends the downlink frame and downlink configuration information to UE. The configuration includes radio resources allocation for the intended services of MBMS only, unicast only, or simultaneous MBMS and unicast traffic type (block 402). Radio frames of the unicast traffic type may be transmitted on PDSCH while radio frames of the MBMS traffic type may be transmitted on PMCH. Radio frames of the simultaneous unicast and MBMS transmission may be transmitted on PDSCH and PMCH.

The UE sends an RRC signaling message called MBMS interest indication message to the NW to indicate to NW that the UE intends to receive or continue receiving MBMS service. As shown in Table 1, according to LTE TS 36.331 clause 6.2.2-MBMSInterestIndication, the MBMS Interest Indication message is included in an IE known as “MBMSinterestindication-r11-IEs”. The IE contains three types of IEs. The first IE is “mbms-FreqList-r11” IE, which includes a list of carrier frequencies on which UE is to or intends to receive MBMS service. The list of carrier frequencies includes Evolved Universal Terrestrial Radio Access (EUTRA) absolute radio frequency channel number (ARFCN) values provided by the parameters of “CarrierFreqListMBMS-r11” IE. The second IE is “mbms-Services-r11” includes a list of MBMS services which the UE (SC-PTM capable only UE) is to or intends to receive via multicast radio bearer (MRB). The list of MBMS services are provided by the parameters “MBMS-ServiceList” IE via TMGI and session ID. The third IE is “mbms-Priority-r11” IE which is used to indicate whether the UE prioritizes MBMS reception over unicast reception and vice versa. For example, presence or a true value of “mbms-Priority-r11” indicates that the UE prioritizes reception of all listed MBMS frequencies over the reception of any of the unicast bearers, and the absence or a false value of this IE indicates that a unicast service has a higher priority than MBMS.

TABLE 1
MBMSInterestIndication message TS 36.331
MBMSInterestIndication-rxx-IEs

| | |
|---|---|
| MBMSInterestIndication-r11-IEs ::= | SEQUENCE { |
| mbms-FreqList-r11 | CarrierFreqListMBMS-r11 |

OPTIONAL,

| | |
|---|---|
| mbms-Priority-r11 | ENUMERATED {true} |

OPTIONAL,

| | |
|---|---|
| nonCriticalExtension | MBMSInterestIndication-v1310-IEs |

OPTIONAL
}

| | |
|---|---|
| MBMSInterestIndication-v1310-IEs ::= | SEQUENCE { |
| mbms-Services-r13 | MBMS-ServiceList-r13 |

OPTIONAL,

| | |
|---|---|
| nonCriticalExtension | MBMSInterestIndication-v1540-IEs |

OPTIONAL,
}

| | |
|---|---|
| MBMSInterestIndication-v1540-IEs ::= | SEQUENCE { |
| mbms-ROM-InfoList-r15 | SEQUENCE (SIZE(1..maxMBMS- |
| ServiceListPerUE-r13)) | |
| | OF MBMS-ROM-Info- |

r15 OPTIONAL,

| | |
|---|---|
| nonCriticalExtension | MBMSInterestIndication-r17-IEs |

OPTIONAL
}

The current definition of “MBMSInterestIndication-r11-IEs” message allows the UE to use “mbms-FreqList-r11” IE which only include the lists of frequencies for MBMS services via MRB, and does not support indication of frequency or frequencies for unicast services to the NW.

That is, a UE using LTE MBMS cannot notify the NW of ongoing unicast services via dedicated radio bearers (DRB). The NW cannot multiplex MBMS and unicast services on a downlink to UE.

The disclosed method provides a new information element in NR MBMS interest indication message, including, for example, “MBMSInterestIndication-r17-IEs.” New IE MBMSInterestIndication-r17-IEs” comprises additional IEs to allow UE to send further information about the ongoing or intended MBMS and unicast services in the indication message to the NW so that the NW can efficiently multiplex MBMS and unicast transmission in NR downlink radio frames. The possible new IEs that can be included in “MBMSInterestIndication-r17-IEs” include:

1) “unicast-FreqList-r17” IE which is used to indicate a list of carrier frequencies on which the UE is to receive unicast services. The carrier frequencies for unicast services may be NR ARFCN values that is provided by the parameter of “CarrierFreqListUnicast-r17” IE; and 2) “unicast-Services-r17” IE which is used to indicate a list the unicast services that the UE is to receive. The unicast services may be evolved packet switched system (EPS) bearers via DRB which is provided by the parameters of “Unicast-ServiceList-r17” IE shown in Table 2 and Table 3. Introducing the new “MBMSInterestIndication-r17-IEs” and the others related IEs may assist the NW on efficiently multiplexing the MBMS and unicast transmission in NR downlink radio frames. The MBMS and unicast transmission may be multiplexed into subframes, slots, or even sub-slots.

TABLE 2
New Information Element “MBMSInterestIndication-r17-IEs”
MBMSInterestIndication-r17-IEs

| | |
|---|---|
| MBMSInterestIndication-v1540-IEs ::= | SEQUENCE { |
| mbms-ROM-InfoList-r15 | SEQUENCE (SIZE(1..maxMBMS- |

ServiceListPerUE-r13))

OF MBMS-ROM-Info-

r15 OPTIONAL,

| | |
|---|---|
| nonCriticalExtension | MBMSInterestIndication-r17-IEs |

OPTIONAL
}

| | |
|---|---|
| MBMSInterestIndication-v17-IEs ::= | SEQUENCE { |
| mbms-FreqList-r17 | CarrierFreqListMBMS-r11 |

OPTIONAL,

| | |
|---|---|
| unicast-FreqList-r17 | CarrierFreqListUnicas-r17 |

OPTIONAL,

| | |
|---|---|
| unicast-Services-r17 | Unicast-ServiceList-r17 |

OPTIONAL,

| | |
|---|---|
| nonCriticalExtension | SEQUENCE { } |

OPTIONAL
}
CarrierFreqListMBMS-r17 ::= SEQUENCE (SIZE (1..maxFreqMBMS-r11)) OF
ARFCN-ValueNR

| | |
|---|---|
| maxFreqMBMS-r11 | INTEGER ::= 5 -- Maximum number of |

carrier freqs on which a UE can indicate

interest.

CarrierFreqListUnicas-r17::= SEQUENCE (SIZE (1.. maxFreq)) OF ARFCN-
ValueNR

| | |
|---|---|
| maxFreq | INTEGER ::= 8 -- Maximum number of frequencies |

supported in NR system.
Unicast-ServiceList-r17 ::= SEQUENCE (SIZE (1..maxDRB)) OF DRB-
ToAddModLIst

| | |
|---|---|
| maxDRB | INTEGER ::= 29 -- Maximum number of DRBs (that can be |

added in DRB-ToAddModLIst).

TABLE 3
Description of the new information element
“MBMSInterestIndication-r17-IEs”
MBMSInterestlndication-v17IEs

mbms-FreqList-r17:
The IE is used to indicate the list of MBMS carrier frequencies on which the
UE is to or intends to receive MBMS via an MRB or SC-MRB. The MBMS
frequencies may be the NR ARFCN values provided by the parameters of
CarrierFreqListMBMS.
unicast-FreqList-r17:
The IE is used to indicate the list of unicast carrier frequencies on which the
UE is to or intends to receive unicast services. The unicast carrier frequencies
may be NR ARFCN values provided by the parameter of
“CarrierFreqListUnicast-r17.”
unicast-Services-r17:
The IE is used to indicate the list of t that the UE is to or intends to receive.
The unicast services may be the EPS bearers via DRB which is provided by
the parameters of “Unicast-ServiceList-x\7 ” IE. The dedicated radio bearers
(DRBs) may be represented by EPS bearer IDs.

With reference to Table 4 extracted from in TS 36.331 clause 5.8.5.3a, in LTE MBMS design, only SC-PTM capable UEs can transmit the information regarding the ongoing MBMS services which is listed in the information element “mbms-Services-r13” of “MBMSInterestIndication-r17-IEs” to the NW.

TABLE 4
Determining MBMS services of interest
5.8.5.3a Determine MBMS services of interest

```
The UE shall:
1> consider a MBMS service to be part of the MBMS services of interest if the
  following conditions are met:
  2> the UE is SC-PTM capable; and
  2> the UE is receiving or interested to receive this service via an SC-MRB; and
  2> one session of this service is ongoing or about to start; and
  2> one or more MBMS SAIs in the USD for this service is included in
    SystemInformationBlockTypel5 acquired from the PCell for a frequency
    belonging to the set of MBMS frequencies of interest, determined according to
    5.8.5.3.
```

With reference to Tables 5, 6, 7, and 8, in the disclosed method, the an MBSFN capable UE, such as one of the UE 10a and UE 10b, transmits “mbms-Services-r17” IE information to the NW. The IE related to MBMS services was introduced since LTE release 13 and can be sent to the network by an SC-PTM capable UE only as captured in TS 36.331. In NR, to include such an IE in the interest indication message for MBSSFN capable UE is useful, because the information provided by “mbms-Services-r17” IE in addition to “unicast-Services-r17” IE can be used by the NW to determine how to multiplex the MBMS and unicast services in NR downlink frames.

TABLE 5
The redefined information element
MBMSInterestIndication-r17-IEs

| | |
|---|---|
| MBMSInterestIndication-r17-IEs ::= | SEQUENCE { |
| mbms-FreqList-r17 | CarrierFreqListMBMS-r11 |

OPTIONAL,

| | |
|---|---|
| unicast-FreqList-r17 | CarrierFreqListUnicas-r17 |

OPTIONAL,

| | |
|---|---|
| unicast-Services-r17 | Unicast-ServiceList-r17 |

OPTIONAL,

| | |
|---|---|
| mbms-Services-r17 | MBMS-ServiceList-r13 |

OPTIONAL,

| | |
|---|---|
| nonCriticalExtension | SEQUENCE { } |

OPTIONAL
}

| | |
|---|---|
| MBMS-ServiceList-r13 ::= | SEQUENCE (SIZE (0..maxMBMS-ServiceListPerUE- |

r13)) OF MBMS-ServiceInfo-r13

| | |
|---|---|
| maxMBMS-ServiceListPerUE-r13 | INTEGER ::= 1 5 -- Maximum number of services |

which UE can include

an interest indication.

TABLE 6
The redefined information element description
MBMSInterestIndication-v17IEs

mbms-ServiceList-r17:
The IE MBMS-ServiceList provides the list of MBMS services. The MBMS
services provided by the parameters “MBMS-ServiceList” include MBMS
service which UE is to or intends to receive through multicast radio bearers
(MRBs) via TMGI, SAI ID, and session IDs.

In LTE MBMS, reception mode related information element that can be sent from the UE to the NW is defined by “mbms-Priority-r11” IE, which may prevent UE to support simultaneous reception of MBMS and uncast services. Because the “mbms-Priority-r11” IE defines the reception mode using a binary or logical variable which can be set either true or false. This binary value of “mbms-Priority-r11” IE allows UE to exclusively support only one of reception modes. That is, at any given subframe, the UE can either receive unicast or MBMS service but not both.

The disclosed method introduces a new information element “reception-Mode-r17” to NR to indicate additional reception modes, and redefines the value of the IE by a categorical variable rather than a logical variable. The categorical variable may be a numeral variable indicating one of the reception modes including unicast only, MBMS only, and simultaneous unicast and MBMS reception modes. The major functionalities of “reception-Mode-r17” IE include:

1). Allowing the UE to support NR features of concurrent unicast and MBMS reception while keeping backward compatibility with legacy LTE MBMS architecture;

2). Assisting the NW to properly multiplex MBMS and unicast transmission in an NR downlink.

TABLE 7
The redefined new information element
MBMSInterestIndication-r17-IEs

| | |
|---|---|
| MBMSInterestIndication-v1540-IEs ::= | SEQUENCE { |
| mbms-ROM-InfoList-r15 | SEQUENCE (SIZE(1..maxMBMS- |
| ServiceListPerUE-r13)) | |
| | OF MBMS-ROM-Info- r15 |

OPTIONAL,

| | |
|---|---|
| nonCriticalExtension | MBMSInterestIndication-r17-IEs |

OPTIONAL,

| | |
|---|---|
| nonCriticalExtension | SEQUENCE { } |

OPTIONAL
}

| | |
|---|---|
| MBMSInterestIndication-r17-IEs: = | SEQUENCE { |
| mbms-FreqList-r17 | CarrierFreqListMBMS-r11 |

OPTIONAL,

| | |
|---|---|
| unicast-FreqList-r17 | CarrierFreqListUnicas-r17 |

OPTIONAL,

| | |
|---|---|
| unicast-Services-r17 | Unicast-ServiceList-r17 |

OPTIONAL,

| | |
|---|---|
| mbms-Services-r17 | MBMS-ServiceList-r13 |

OPTIONAL,

| | |
|---|---|
| reception-Mode-r17 | ENUMERATED {unicast, mbms, |

simultaneous} OPTIONAL,

| | |
|---|---|
| nonCriticalExtension | SEQUENCE { } |

OPTIONAL
}

TABLE 8
Description of the new information element
“MBMSInterestIndication-v17IEs”
MBMSInterestlndication-v17IEs

Reception-Mode-r17:
The IE is used to indicate a reception mode of the UE. In a unicast reception
mode, the UE only receives unicast services. In an MBMS reception mode,
the UE only receives MBMS services. In a simultaneous unicast and MBMS
reception mode, the UE concurrently receives MBMS and unicast services.

The disclosed method, the proposed information elements may be transmitted from UE to NW in an interest indication message, an MBMScountingRespone message, or any other alternative way.

Two examples of the disclosed method using the proposed new IEs are detailed in the following. The NW may interpret the IEs to allocate and configure PDSCH and PMCH transmission in downlink. One example is single band MBMS deployment, and the other is multiband deployment in NR.

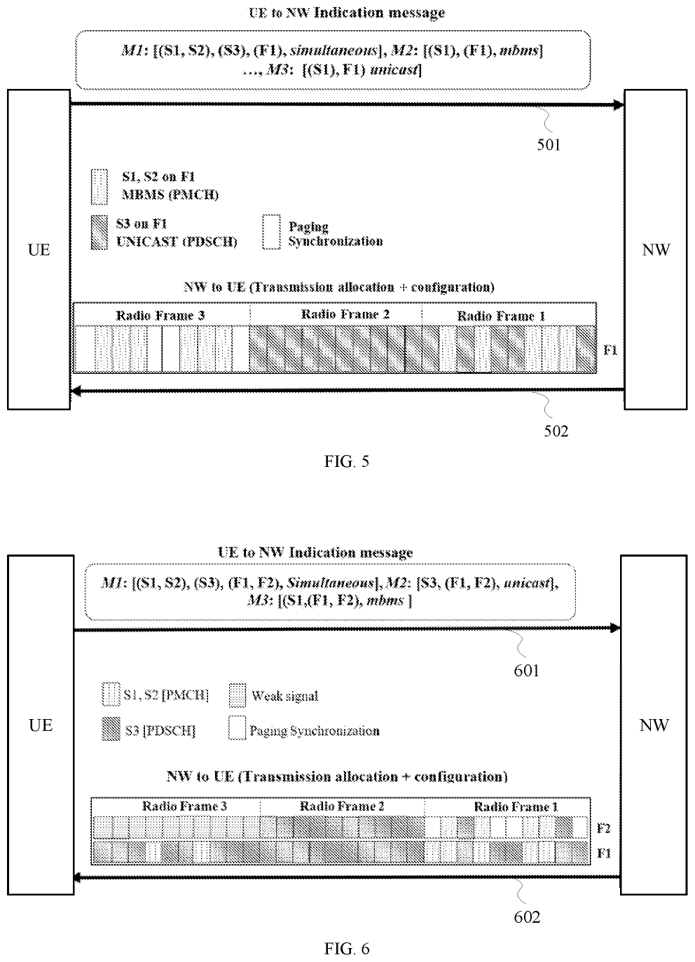

With reference to FIG. 5, in the example of single band MBMS deployment, the UE in an RRC connected mode camps on a frequency band F1 in a NW with single band deployed MBMS, and intends to receive MBMS services. The UE may initially intend to receive two MBMS services, such as a news service (S1) and a sports service (S2), and simultaneously a unicast service (S3), such as file download. The UE may transmit an MBMS interest indication message 501 to the NW to indicate the intended MBMS services S2 an S3 and the unicast service S3 (step 501). The interest indication message may include the frequency F1 in the fields of mbms-FreqList-r17 and unicast-FreqList-r17 IEs, the MBMS services (S1, S2) in the field of mbms-Services-r17 and the unicast service S3 in unicast-Services-r17, and a traffic type value of “simultaneous” representing a reception mode of the UE in the felid of “Reception-Mode-r17”. As shown in FIG. 5, the indication message may be represented by a message M1: [(S1,S2),(S3),(F1), Simultaneous]. After receiving the indication message M1 from UE, the NW identifies the message and determines that simultaneous transmission of PMCH and PDSCH on a single frequency is required for a current NR downlink radio frame. Consequently, the NW multiplexes the transmission of PDSCH and PMCH, for example, in time domain at granularity of a subframe, in the NR downlink radio frame 1 in response to the message M1 (step 502). Subsequently, when the news service S2 and sports service S3 stop temporarily, the UE transmits another indication message M2: [(S3), (F1), unicast] to the NW. In response to the message M2, the NW changes the NR downlink configuration to generate NR downlink radio frame 2 which only includes PDSCH the unicast service S3. Similarly, when file download completes and the sports service S2 is resumed, the UE transmits another indication message M3: [(S2), (F1), mbms] to the NW. In response to the message M3, the NW changes the NR downlink configuration to generate NR downlink radio frame 3 which includes PMCH channel only for MBMS services S1 and S2. Note that some subframes were left for paging and synchronization according to current LTE design but may be alterable.

Accordingly, the UE transmits an indication message to the NW to indicate a first intended service of a first traffic type and a second intended service of a second traffic type. The first intended service may include the service S1 and S2 of the MBMS traffic type, and the second intended service may include the service S3. The first traffic type may be MBMS traffic, and the second traffic type may be unicast traffic. The NW receives the indication message, configures a downlink on frequency F1 to the UE based on the indication message, and transmit a downlink frame, such as one of the radio frames 1, 2, and 3 in FIG. 5, according to the downlink configuration. The UE receives the downlink configuration which is generated based on the indication message. The UE receives the downlink frame carrying the first intended service and the second intended service according to the downlink configuration.

In an embodiment of the disclosure, the UE receives a first radio resource unit of the first intended service and a second radio resource unit of the second intended service according to the downlink configuration. The first radio resource unit and the second radio resource unit may be subframes, sub-slots, or mini-slots, that are multiplexed into different time slots on a same frequency band F1.

With reference to FIG. 6, in the example of Multiband MBMS deployment, the UE may request MBMS services including the news service (S1), the sports service (S2), and unicast services, such as file download (S3). When intending to receive one or more of these service on multiple frequencies, such as F1 and F2, the UE can send an indication message indicating these carrier frequencies and services to the NW (step 601). The transmitted indication message may be represented by M1: [(S1, S2), (S3), (F1, F2), Simultaneous]. According to the indication message, the network can determine that the multiplexing of PMCH and PDSCH on different frequencies F1 and F2 in a current radio frame is required for the services S1, S2, and S3. Subsequently, in response to the message M1, the NW allocates, for example, a PDSCH channel on first frequency F1 and a PMCH channel on second frequency F2 in a radio frame 1 shown in FIG. 6 (step 602), so that the UE can receive MBMS services and unicast service simultaneously. Similarly, to stop the MBMS services S1 and S2 on F1 and F2, and continue the unicast service S3 on F1 and F2, the UE may use an indication message represented by a message M2: [S3, (F1, F2), unicast] to indicate both F1 and F2 to the NW as the frequencies for the unicast service S3. The network may in response to the indication message M2 allocate the PDSCH channel on both frequencies F1 and F2 in radio frame 2. Subsequently, the UE may move to a place where the signal of the second frequency F2 is weak while one of the MBMS services, such as S2, is resumed, and the unicast service S3 is still ongoing. The UE may transmit an indication message M3: [S2, S3, (F1), Simultaneous] to the NW. In response to the message M3, the NW may allocate and configure PDSCH and PMCH in a radio frame 3 as illustrated in FIG. 6.

As detailed in the two examples, IEs for indicating intended services of specific traffic types, carrier frequencies, and reception mode of UE are redefined to allow the simultaneous transmission and reception of MBMS and unicast in NR while keeping a backward compatibility with current LTE MBMS architecture. The information elements in the disclosure provide beneficial effects to the UE and NW. The NW may allocate dynamic transmission of PMCH and PDSCH in a downlink radio frame. The UE may indicate intended unicast and MBMS services in an indication message using the IEs. The NW may allocate radio resources, such as subframes, sub-slots, or mini-slots, in each downlink radio frame for PMCH and PDSCH channels in response to the indication message. The allocation of radio resources in one radio frame for PMCH and PDSCH channels may be represented by percentages.

Similarly, the UE transmits an indication message to the NW to indicate a first intended service of a first traffic type and a second intended service of a second traffic type. The first intended service may include the service S1 and S2 of the MBMS traffic type, and the second intended service may include the service S3. The first traffic type may be MBMS traffic, and the second traffic type may be unicast traffic. The NW receives the indication message, configures a downlink to the UE on frequencies F1 and F2 based on the indication message, and transmit a downlink frame, such as one of the radio frames 1, 2, and 3 in FIG. 6, according to the downlink configuration. The UE receives the downlink configuration which is generated based on the indication message. The UE receives the downlink frame carrying the first intended service and the second intended service according to the downlink configuration.

In an embodiment of the disclosure, the UE receives a first radio resource unit of the first intended service and a second radio resource unit of the second intended service according to the downlink configuration. The first radio resource unit and the second radio resource unit may be subframes, sub-slots, or mini-slots, that are multiplexed on different frequency bands F1 and F2.

The UE transmits an information element to indicate a MBMS service list to the network in both SC-PTM and MBSFN operation modes. The network receives the information element indicating a MBMS service list intended by a user equipment in both SC-PTM and MBSFN operation modes and utilizes the information element to determine allocation of a unicast service versus a multicast/broadcast service on the downlink frame.

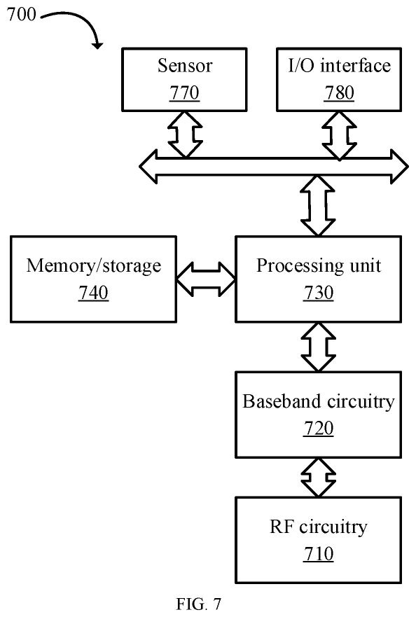

FIG. 7 is a block diagram of an example system 700 for wireless communication according to an embodiment of the present disclosure. Embodiments described herein may be implemented into the system using any suitably configured hardware and/or software. FIG. 7 illustrates the system 700 including a radio frequency (RF) circuitry 710, a baseband circuitry 720, an application circuitry 730, a memory/storage 740, a sensor 770, and an input/output (I/O) interface 780, coupled with each other at least as illustrated.

The application circuitry 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitries, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

In the disclosure, IEs for indicating intended services of specific traffic types, carrier frequencies, and reception mode of UE are redefined to allow the simultaneous transmission and reception of MBMS and unicast in NR while keeping a backward compatibility with current LTE MBMS architecture. The information elements in the disclosure provide beneficial effects to the UE and NW. The NW may allocate dynamic transmission of PMCH and PDSCH in a downlink radio frame. The UE may indicate intended unicast and MBMS services in an indication message using the IEs. The NW may allocate radio resources, such as subframes, sub-slots, or mini-slots, in each downlink radio frame for PMCH and PDSCH channels in response to the indication message.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims

1. A method for unicast, broadcast, and multicast services, executable by a user equipment, comprising:
transmitting an indication message to indicate a first intended service of a first traffic type and a second intended service of a second traffic type, wherein one of the first traffic type and the second traffic type is unicast traffic, and the other one of the first traffic type and the second traffic type is non-unicast traffic;
receiving downlink configuration which is generated based on the indication message; and
receiving a downlink frame carrying the first intended service and the second intended service according to the downlink configuration.

2. The method of claim 1, wherein the indication message further comprises a list of at least one of the intended services.

3. The method of claim 2, wherein the indication message further comprises a list of carrier frequencies of the at least one of intended services.

4. The method of claim 3, wherein the indication message further comprises a reception mode for receiving the first intended service and the second intended service.

5. The method of claim 4, wherein the reception mode comprises one of a unicast reception mode, a non-unicast reception mode, and a simultaneous unicast and non-unicast reception mode.

6. The method of claim 5, wherein the non-unicast reception mode comprises at least one of a broadcast, a multicast, or group cast reception mode.

7. The method of claim 1, wherein the non-unicast traffic comprises at least one of broadcast traffic, multicast traffic, and groupcast traffic.

8. The method of claim 1, further comprising:
receiving a first radio resource unit of the first intended service and a second radio resource unit of the second intended service according to the downlink configuration, wherein the first radio resource unit and the second radio resource unit are multiplexed into different time slots on a same frequency band.

9. The method of claim 1, further comprising:
receiving a first radio resource unit of the first intended service and a second radio resource unit of the second intended service according to the downlink configuration, wherein the first radio resource unit and the second radio resource unit are multiplexed on different frequency bands.

10. The method of claim 1, further comprising:
transmitting an information element to indicate the intended services to a network, wherein the information element is used by the network to determine allocation of a unicast service versus a multicast/broadcast service on the downlink frame.

11. A method for unicast, broadcast, and multicast services, executable by a network device, comprising:
receiving an indication message indicating a first intended service of a first traffic type and a second intended service of a second traffic type, wherein one of the first traffic type and the second traffic type is unicast traffic, and the other one of the first traffic type and the second traffic type is non-unicast traffic;
transmitting downlink configuration which is generated based on the indication message; and
transmitting a downlink frame carrying the first intended service and the second intended service according to the downlink configuration.

12. The method of claim 11, wherein the indication message further comprises a list of intended services including the first intended service and the second intended service.

13. The method of claim 12, wherein the indication message further comprises a list of carrier frequencies for the first intended service and the second intended service.

14. The method of claim 13, wherein the indication message further comprises a reception mode for receiving the first intended service and the second intended service.

15. The method of claim 14, wherein the reception mode comprises one of a unicast reception mode, a non-unicast reception mode, and a simultaneous unicast and non-unicast reception mode.

16. The method of claim 15, wherein the non-unicast reception mode comprises at least one of a broadcast, a multicast, or group cast reception mode.

17. The method of claim 11, wherein the non-unicast traffic comprises at least one of broadcast traffic, multicast traffic, and groupcast traffic.

18. The method of claim 11, further comprising:
transmitting a first radio resource unit of the first intended service and a second radio resource unit of the second intended service according to the downlink configuration, wherein the first radio resource unit and the second radio resource unit are multiplexed into different time slots on a same frequency band.

19. The method of claim 11, further comprising:
transmitting a first radio resource unit of the first intended service and a second radio resource unit of the second intended service according to the downlink configuration, wherein the first radio resource unit and the second radio resource unit are multiplexed on different frequency bands.

20. (canceled)

21. An apparatus comprising:
a transceiver; and
a processor connected with the transceiver and configured to execute the following steps comprising:
transmitting an indication message to indicate a first intended service of a first traffic type and a second intended service of a second traffic type, wherein one of the first traffic type and the second traffic type is unicast traffic, and the other one of the first traffic type and the second traffic type is non-unicast traffic;
receiving downlink configuration which is generated based on the indication message; and
receiving a downlink frame carrying the first intended service and the second intended service according to the downlink configuration.

22-48. (canceled)
